(19) United States
(12) Patent Application Publication
(10) Pub. No.: US 2017/0039895 A1
(43) Pub. Date: Feb. 9, 2017

(54) BAG CLIP WITH FRESHNESS INDICATOR

(71) Applicant: Robinson Home Products Inc., Williamsville, NY (US)

(72) Inventors: Lou Henry, Scarsdale, NY (US); John Healy, Brooklyn, NY (US)

(21) Appl. No.: 14/816,751

(22) Filed: Aug. 3, 2015

(51) Int. Cl. G09D 3/06; G09F 11/23; B65D 33/16

(52) U.S. Cl. CPC G09D 3/06; B65D 33/1675; G09F 11/23

(57) ABSTRACT

A bag resealing clip comprising cooperating bag cinching members for retaining at least a portion of a bag to be resealed in a substantially closed state, and a date display with display indicia that is user definable associated with at least one of the bag cinching members.

### FIELD OF THE INVENTION

The present invention relates to household items, especially kitchen items, and more particularly to bag resealing clips used to reseal a bag after it has been originally opened, to maintain the freshness of the contents.

### BACKGROUND OF THE INVENTION

Reusable bag resealing clips are used in the home, and most often in the kitchen, for resealing bags when the contents are not fully used, to help keep the contents fresh for extended periods of time. Bag resealing clips have become a household staple, allowing consumers to spread a bagged item's shelf life for days after it has been opened and to close a bag without risk of the bag reopening accidentally.

However, a bag with a resealing clip may sit on a shelf or in a pantry for a long period of time without being used. Although such devices aid to slow staling or spoilage, they cannot entirely prevent staling and spoilage. Without indication of when a bag was sealed, the contents may lose its appeal if the bag is left for an extended period of time without being consumed. Moreover, consumers may be caught unaware that the contents are becoming stale, since the expiration date of most packaged products are vague and far off dates that do not help narrow down when a product was opened.

Therefore, a bag resealing clip with an indicator of the date the bag was sealed would be an advance in the art.

### SUMMARY OF THE INVENTION

It is one of a number of objects of the present invention to provide a bag resealing clip to reseal bags for increasing the usable life of the contents. It is another main object of the invention to provide an indication of when a bag was sealed or when the freshness of the contents is expected to expire.

These and other objects are achieved by the present invention, which is directed to a bag resealing clip comprising cooperating bag cinching members for receiving at least a portion of a bag to be resealed, date indicia and movable elements related to the date indicia.

The bag resealing clip can comprise any known cooperating bag cinching members, including those having multiple component parts which together are capable of resealing a bag.

Most preferably, the present invention is directed to a bag resealing clip comprising cooperating spring loaded cinching members that can be forced open for receiving at least a portion of a bag opening and allowed to close about the bag opening. Such bag resealing clips are generally in the form of a pivoting spring clip with cooperating arms each having a clamping end, an open end and a connection pivot therebetween, with one or more springs that force the clamping ends together when there is no force acting on the open ends.

Other suitable bag resealing clips can be in the form of a depression clip, with an outer member having an opening in the side and a cooperating inner member that is spring loaded and travels axially within the outer member. In such an embodiment, the inner member also has an opening in its side that cooperates with the opening in the outer member, such that when the inner member is depressed against the force of the spring the openings of the inner and outer members align and when the inner member is released the openings close about at least a portion of the bag opening.

Of course, the bag cinching members of the present invention can be clamping members that are manually closed about at least a portion of an open end of a bag and held or locked together with a snap, clasp, catch, etc. These manual clips generally comprise two sections with a pivot at a closed end and a locking member at an open end, but do not have a spring to force the open end into a closed orientation. They are opened at the locking member end so that the bag opening can be placed between the sections, after which the sections are brought together and locked at the open end to clamp the sections about the bag opening.

The date indicia is most preferably in the form of month indicia and day indicia. The month indicia can be in the form of the numerical month, but is preferably in the form of literal month abbreviations. The day indicia is preferably in the form of two independent lines, the first with the numbers 0, 1, 2, and 3, for the first day integer, and the second line with each of the numbers 0-9 for the second day integer.

Although any movable elements that display the date indicia may be used, including sliding, rotating or other movable members, the use of rotating movable elements is most preferred. In such an embodiment, the movable elements comprise one or more axels and a plurality of date identifying wheels that may be rotated on said one or more axels in order to display a month and date, ideally when the subject bag was first opened.

The one or more axels and wheels may be placed in any suitable location on the bag resealing clip, but are preferably placed on or near an open end of one of the cooperating arms when using a pivoting spring clip or manual clip and along the outer member when using a depression clip. Of course, the placement of the date indicia may be on the clamping or locking end of the pivoting spring clip or manual clip, or on the inner cooperating member of the depression clip.

When using rotating movable elements comprising one or more axels and wheels, a single axel about which each of the wheels are rotated is preferred. It is also preferred that the first wheel comprise the month indicia in the form of the month abbreviation, a second wheel with the first day integer and a third wheel with the second day integer. This permits the user to set the month and the day, including days with two day integers, with wheels having no more than 12 assigned indicium.

The wheels are meant to rotate about the axle, in order to change the date for use between different bags, and can be set to display a user determined month and day, preferably the date when the bag being resealed was first opened. A line indicating the central symmetry as to clearly specify the date indicia set is also preferred. When used with a pivoting spring clip or manual clip the wheels are preferably placed on the cooperating arms, with the indicium viewable through small windows. However, in an alternative embodiment, the wheels may be made to fit around the outside of the cooperating arms of the pivoting spring clip or manual clip, or the inner or outer members of the depression clip, and viewable without windows. In this case, an indicator is preferably used to display which indicium is being referenced.

Alternative movable elements related to the date indicia may be used, as a matter of design choice in various embodiments. These may include sliding tabs with setting indicators along a line of months and days, a series of dials with date indicia thereon, a digital display with the visual aspect movable to display different dates, or the like, as well as any combination thereof. Moreover, and especially with a digital display, the date indicia may be a countdown indicia rather than indicia showing when the bag was opened.

In any event, care should be used so that the movable elements are not interfered with when opening or closing the resealable bag clip.

### BRIEF DESCRIPTION OF THE DRAWINGS

The attached drawings are intended to better illustrate a preferred embodiment of the present invention without limiting the invention in any manner whatsoever.

FIG. 1 is a perspective view of an embodiment of the present invention.

FIG. 2 is an exploded view of an embodiment of the present invention shown in FIG. 1.

FIG. 3A is a side elevation of the date identifying wheel of an embodiment of the present invention.

FIG. 3B is a side elevation of an alternative version of the date identifying wheel of an embodiment of the present invention.

FIG. 3C is a front elevation of a date identifying wheel of an embodiment of the present invention, wherein the literal designation for the month is displayed.

FIG. 3D is a front elevation of a date identifying wheel of an embodiment of the present invention, wherein the numerical designation of a date is displayed.

FIG. 4 is a perspective view of an alternative embodiment of the present invention.

FIG. 5 is an exploded view of the alternate embodiment of the present invention shown in FIG. 4.

### DETAILED DESCRIPTION OF THE PREFERRED EMBODIMENT

The following description of the preferred embodiment is presented to describe the present invention without limiting invention, defined by the scope of the appended claims, in any manner whatsoever.

The present invention is directed to a bag clip 2 comprising a bag cinching member 4, preferably in the form of cooperating clip elements 8 and 10, and a date display 6, preferably in the form of a series of rotatable wheels 12 having indicia that can correspond to a date.

The cooperating first and second clip elements 8 and 10 of the bag cinching member 4 can be any suitable elements that cooperate to retain a bag in a substantially closed configuration. Although the preferred embodiments shown comprise cooperating clip elements 8 and 10 that are spring loaded to force clamping portions into a closed orientation, the cinching member 4 may be, for example, two flexible arms that retain their shape, with the date display 6 therebetween, so that the flexible arms can be intertwined to secure the open end of the bag in a substantially closed state.

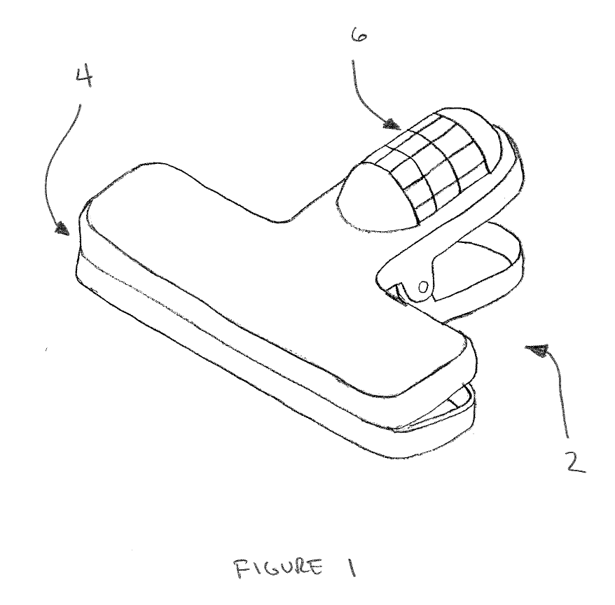

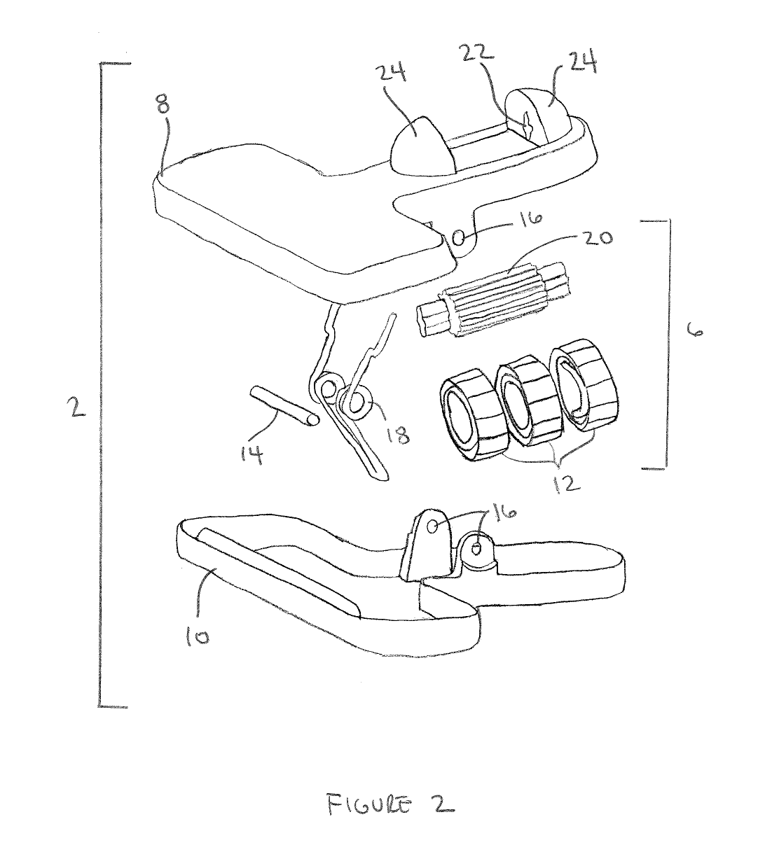

In the preferred embodiment of FIGS. 1-2, the first clip element 8 and the second clip element 10 are connected by a pin 14 at corresponding fulcrum points 16. A spring member 18, preferably fixed by the pin 14, biases the clamping portions of the cooperating first and second clip elements 8 and 10 into a closed orientation for retaining a bag in a substantially closed state.

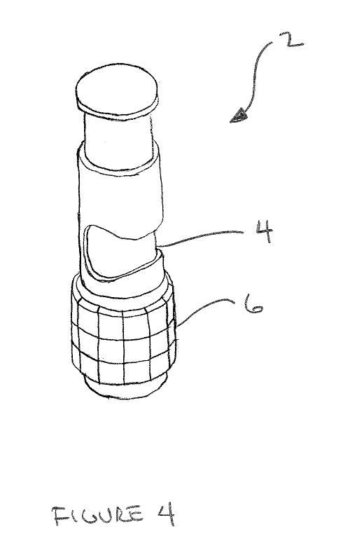

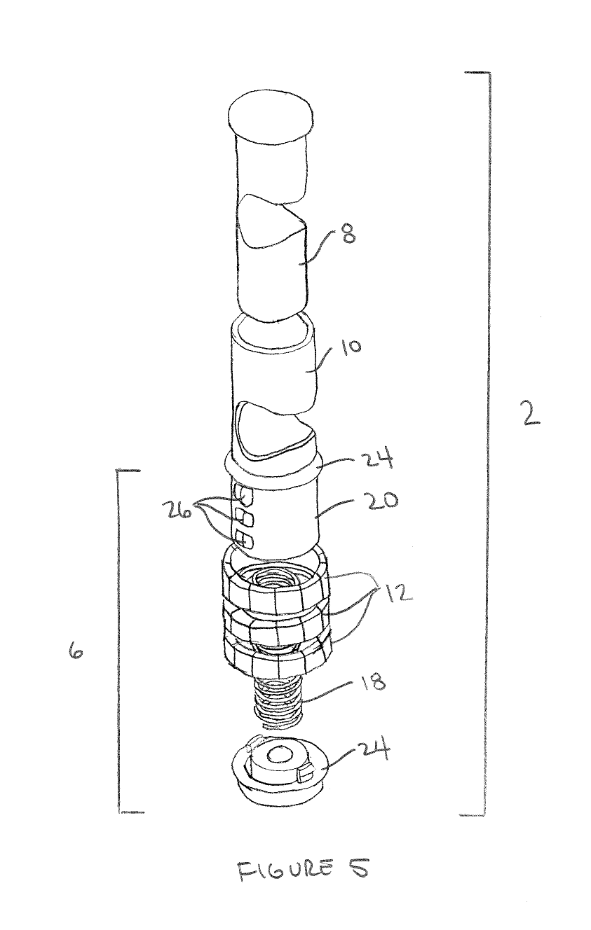

Similarly, in the preferred embodiment of FIGS. 4 and 5, the first clip element 8 is a plunger with an opening on a side that travels within the second clip element 10, which is in the form of a sleeve having a corresponding side opening that forms. A spring member 18, preferably biases the first clip element 8 against the second clip element 10 so that the corresponding openings of the first clip element 8 and the second clip element 10 form clamping portions for retaining a bag in a substantially closed state.

The bag clip 2, regardless of the cinching member 4 used, includes a date display 6, preferably comprising moving elements that permit the user to define the date on the display 6. In the preferred embodiment shown, the date display 6 comprises a series of rotatable wheels 12, having indicia thereon that can be used to define a date, which rotate about an axel 20. The rotatable wheels 12 of the date display 6 are preferably integrated on at least one of the cooperating first and second clip elements 8 and 10. The interior of the wheels 12 preferably fit snugly around a fixed axle 20, with one of the interior of the wheels 12 and the exterior of the axel 20 having detents that engage depressions on the other. The detents and depressions cooperate to hold the wheels 12 from unintentional rotation, while permitting rotation of the wheels 12 on the axel 20 when sufficient rotational force is applied to the wheels 12.

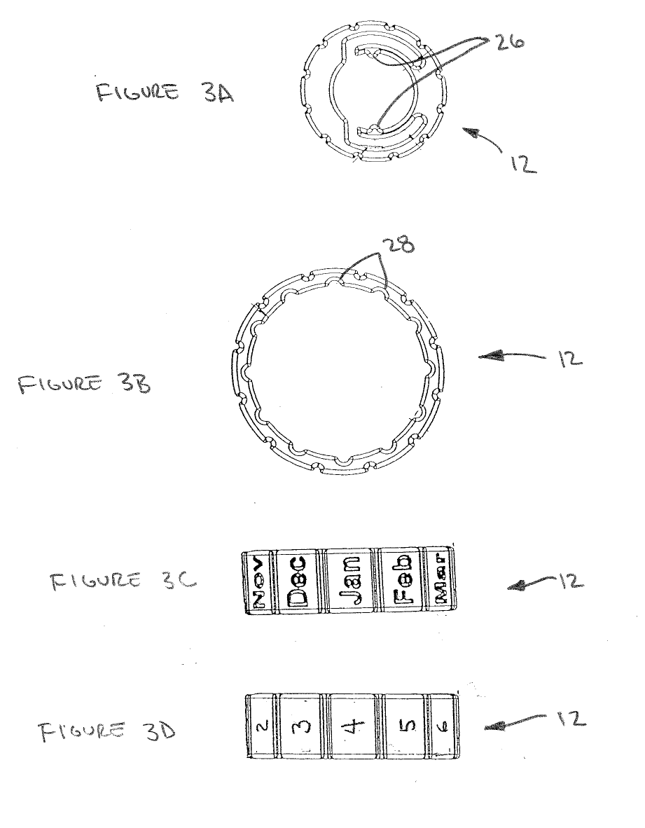

For example, as shown in FIG. 3A, preferably for use with the clip 2 of FIGS. 1 and 2, the wheels 12 have detents 26 that engage depressions 28 on the axel 20. Alternatively, as shown in FIG. 3B, preferably for use with the clip 2 of FIGS. 4 and 5, the wheels have depressions 26 that are engaged by detents 28 on the portion of the clip member 10 that forms the axel 20.

In the embodiment of FIGS. 1 and 2, the first clip element 8 comprises retainers 22 for holding the axel 20 in a fixed position, with the rotatable wheels 12 fitted on the axel 20. Although the retainers 22 are shown as fashioned on raised stops 24, for fixing the position of the wheels 12, on the side of the clip member opposite the clamping end, it is understood that the retainers 22, and therefore the date display 6, can be on any suitable area of the clip 2.

Moreover, the retainers 22 shown in FIGS. 1 and 2 are set on raised stops 24 on the clip member 8, which preferably have rounded ends to limit their catching on other objects. However, it is understood that the retainers 22 can be set within inset stops 24 on the clip members 8 and/or 10.

In the alternative embodiment of FIGS. 4 and 5, the axel 20 can be incorporated onto a portion of the second clip member 10, where the wheels 12 rotate about the portion of the second clip member 10 opposite the clamping openings. As shown in FIG. 5, the end of the clip member 10 on which the wheels 12 rotate have stops 24 for fixing the position of the wheels 12, and detents 26 that cooperate with depression on the interior of the wheels 12 to retain the wheels in a user defined orientation.

As shown in FIG. 3C, the wheels 4 are preferably printed with the names of months and a series of numbers in order to correspond to a date. Of course, the months can be shown in numerical form, i.e., from 1-12, rather than literal form. Moreover, the days are preferably shown in numerical form using two wheels for the days, including wheels with the indicial 0-9 on each or a first wheel with 0-3 for the first integer of the date and a second wheel with 0-9 for the second integer of the day. In this regard, the appended drawings show the wheels 12 in FIGS. 1, 2, 3A, 3B, 4, and 5 as blank, but it is to be understood that the wheels 12 include date indicia, either with the literal indicia shown in FIG. 3C or with numerical indicia (not shown), for the user to define the date. During use, the wheels 12 may define a date when a bag was first opened, so that the user knows how long the bag has been opened and can thereby determine the freshness of the contents. Of course, the date display 6 need not be a set of wheels 4, but may comprise a digital display, a series of sliding elements where either the indicia or an indicator line slides to a user set position, etc., so that the user can define a date. Moreover, an indicator line or a window opening is preferably used with the date display 6, so that the particular indicia corresponding to the date is clearly designated. Additionally, the clip 2 may comprise a date display 6 on more than one of the first and second clip members 8 and 10, for example, where a month indicia is presented on a first clip element and a day indicia is presented on a second clip element.

Variations, modifications and alterations to the above detailed description will be readily apparent to those skilled in the art. All such variations, modifications and/or alternatives are intended to fall within the spirit and scope of the present invention, limited only by the appended claims.

We claim:

1. A bag resealing clip comprising cooperating bag cinching members for retaining at least a portion of a bag to be resealed in a substantially closed state, and a date display with display indicia that is user definable associated with at least one of the bag cinching members.

2. The bag resealing clip of claim 1 wherein the date display comprises one or more movable elements having date indicia printed thereon.

3. The bag resealing clip of claim 2 wherein the movable elements comprise a plurality of wheels rotatable around an axel.

4. The bag resealing clip of claim 4 wherein one of the wheels and the axel have one or more detents that cooperate with a series of depressions on the other of the wheel and the axel.

5. The bag resealing clip of claim 3 further comprising one or more retainers for fixing the axel on at least one of the cooperating bag cinching members.

6. The bag resealing clip of claim 3 further comprising one or more stops for maintaining the orientation of the wheels.

7. The bag resealing clip of claim 1 wherein the cooperating bag cinching members comprise first and second clip elements.

8. The bag resealing clip of claim 7 wherein the first and second clip elements are spring loaded to bias clamping portions of the first and second clip elements in a closed orientation.
